(19) United States
(12) Patent Application Publication
(10) Pub. No.: US 2013/0300685 A1
(43) Pub. Date: Nov. 14, 2013

(54) OPERATION METHOD OF TOUCH PANEL

(71) Applicant: KYE SYSTEMS CORP., New Taipei City (TW)

(72) Inventors: Tsung-Hsien SHEN, New Taipei (TW); Jui-Tse CHEN, New Taipei (TW)

(73) Assignee: KYE SYSTEMS CORP., New Taipei City (TW)

(21) Appl. No.: 13/803,998

(22) Filed: Mar. 14, 2013

(30) Foreign Application Priority Data
May 11, 2012 (TW) 101116953

(51) Int. Cl. G06F 3/041

(52) U.S. Cl. CPC G06F 3/0416
USPC 345/173

(57) ABSTRACT

An operation method of a touch panel includes the following steps. A touch signal generated when the touch panel senses a touch is received. According to the touch signal, whether a location of the touch moves from a triggering zone to a working zone on the touch panel is determined. When the location of the touch moves to the working zone from the triggering zone, the touch panel is controlled to operate under a multi-touch mode. When the location of the touch does not move to the working zone form the triggering zone, the touch panel is controlled to operate under a mouse mode.

### CROSS-REFERENCE TO RELATED APPLICATIONS

This non-provisional application claims priority under 35 U.S.C. §119(a) on Patent Application No(s). 101116953 filed in Taiwan, R.O.C. on May 11, 2012, the entire contents of which are hereby incorporated by reference.

### BACKGROUND

1. Technical Field

The disclosure relates to an operation method of a touch panel, and more particularly to an operation method of a touch panel having dual operation modes.

2. Related Art

With the development of technology, the design of electronic devices becomes more user friendly, so that it becomes more convenient and easy to operate electronic devices. In recent years, the input manner of electronic devices has changed to the present touch input manner, e.g. touching by fingers or a touch pen, from the conventional input manner, e.g. typing a keyboard or pressing bottoms. Such a present touch input manner can be used for simplifying the configurations of bottoms and switches, and the user can also operate an electronic device with the present input manner more directly and faster. Moreover, such a touch input manner has been applied widely to various electronic devices, e.g. a mobile phone, a personal digital assistant (PDA) and a hand-writing panel.

The touch device has various types, for example, a resistor type, a capacitor type and an electromagnetic type, with various touch manners. A conventional touch input manner is limited by the structure of a touch device, so that the conventional touch input manner only can perform the single touch sensing, e.g. the input function of regular mice, to support the simplest operation, i.e. the command inputting with a single touch operation.

As the continuous research and development of touch devices, the touch device can perform not only the single touch sensing but also a multi-touch sensing. The multi-touch sensing makes the input of commands, e.g. browsing, icon selecting, hand writing, data inputting, screen arrangement, screen zooming-in-and-out, photo selecting and photo moving, become easier. However, if the conventional touch device is used for performing the multi-touch sensing, it will be necessary to additionally use other input devices simultaneously, thereby causing the conventional touch device not be convenient to use.

### SUMMARY

An operation method of a touch panel according to an embodiment of the disclosure includes the following steps. A touch signal is received, and the touch signal is generated when the touch panel senses a touch. Whether a location of the touch moves from a triggering zone to a working zone on the touch panel is determined according to the touch signal. When the location of the touch moves from the triggering zone to the working zone, the touch panel is controlled to operate under a multi-touch mode. When the location of the touch does not move from the triggering zone to the working zone, the touch panel is controlled to operate under a mouse mode.

In an embodiment, when the location of the touch moves from the triggering zone to the working zone, the step of controlling the touch panel to operate under the multi-touch mode includes the following steps. Whether the location of the touch moves from the triggering zone to the working zone successively is determined. When the location of the touch moves from the triggering zone to the working zone successively, the touch panel is controlled to operate under the multi-touch mode. When the location of the touch does not move from the triggering zone to the working zone successively, the step of receiving the touch signal is returned.

In an embodiment, when the location of the touch does not move from the triggering zone to the working zone successively, the operation method further includes the following steps before the step of returning to the step of receiving the touch signal. Whether the touch is removed from the working zone is determined. When the touch is not removed from the working zone, the step of determining whether the touch is removed from the working zone is returned. When the touch is removed from the working zone, the step of receiving the touch signal is performed is returned.

In an embodiment, when the touch is removed from the working zone, the operation method further includes the following steps before the step of returning to the step of receiving the touch signal. Whether a time period the touch is removed from the working zone is greater than a preset value is determined. When the time period is greater than the preset value, the step of receiving the touch signal is returned. When the time period is not greater than the preset value, the step of determining whether the time period the touch is removed from the working zone is greater than the preset value is returned.

In an embodiment, the operation method further includes the following steps after the step of controlling the touch panel to operate under the multi-touch mode. Whether the touch is removed from the working zone is determined. When the touch is not removed from the working zone, the touch panel continuously operates under the multi-touch mode. When the touch is removed from the working zone, the step of receiving the touch signal is returned.

In an embodiment, when the touch is removed from the working zone, the operation method further includes the following steps before the step of returning to the step of receiving the touch signal. Whether a time period the touch is removed from the working zone is greater than a preset value is determined. When the time period is greater than the preset value, the step of receiving the touch signal is returned. When the time period is not greater than the preset value, the touch panel continuously operates under the multi-touch mode.

In an embodiment, the operation method further includes the following steps after the touch panel is controlled to operate under the mouse mode. Whether the touch is removed from the working zone is determined. When the touch is not removed from the working zone, the touch panel continuously operates under the mouse mode. When the touch is removed from the working zone, the step of receiving the touch signal is returned.

In an embodiment, when the touch is removed from the working zone, the operation method further includes the following steps before the step of returning to the step of receiving the touch signal. Whether a time period the touch is removed from the working zone is greater than a preset value is determined. When the time period is greater than the preset value, the step of receiving the touch signal is returned. When the time period is not greater than the preset value, the touch panel continuously operates under the mouse mode.

In an embodiment, when the location of the touch does not move from the triggering zone to the working zone, the step of controlling the touch panel to operate under the mouse mode includes the following steps. Whether the touch occurs by directly touching the working zone is determined. When the touch occurs by directly touching the working zone, the touch panel operates under the mouse mode. When the touch occurs by not directly touching the working zone, the step of receiving the touch signal is returned.

### BRIEF DESCRIPTION OF THE DRAWINGS

The disclosure will become more fully understood from the detailed description given herein below for illustration only, thus does not limit the disclosure, wherein:

FIG. 1 is a schematic diagram of a touch device according to an embodiment of the disclosure;

FIG. 2 is a flow chart of an operation method of the touch device according to an embodiment of the disclosure; and

FIG. 3A and FIG. 3B illustrate a flow chart of an operation method of the touch device according to another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

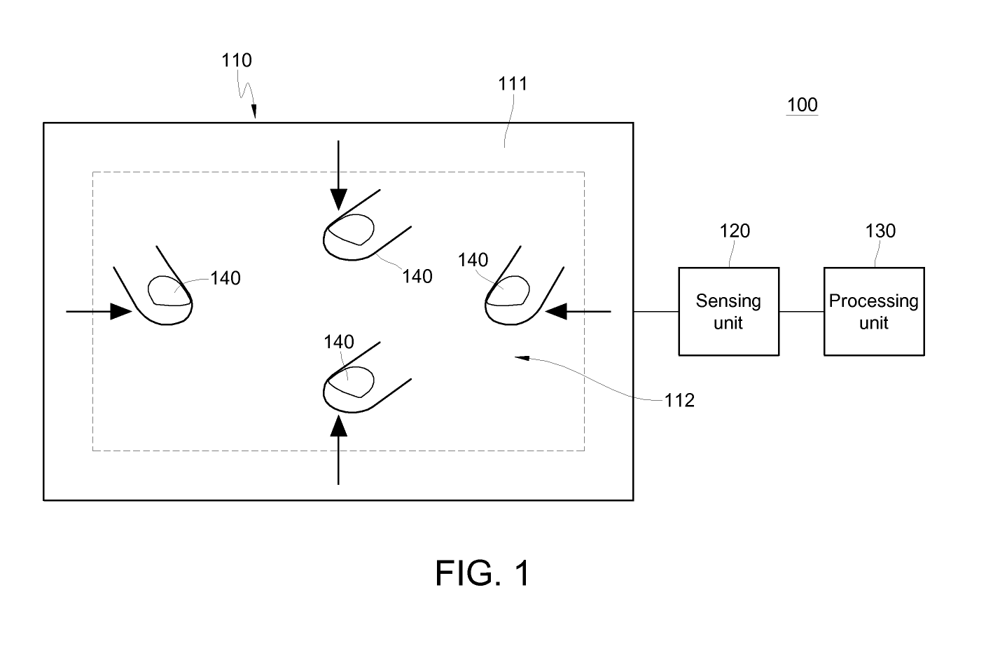

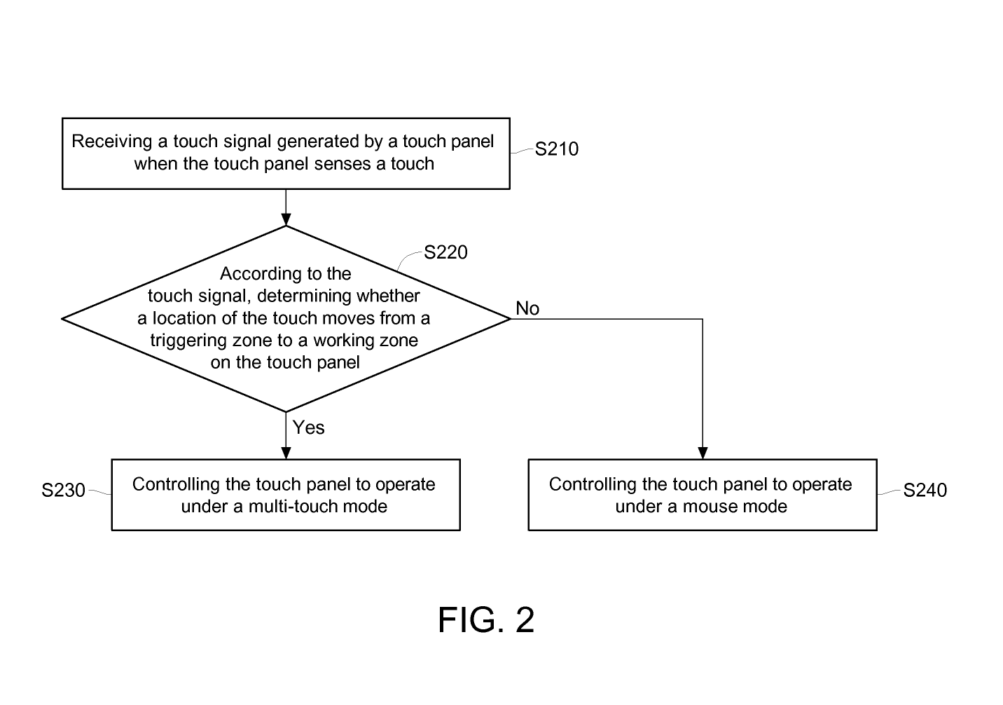

FIG. 1 and FIG. 2 are respectively a schematic diagram of a touch device and a flow chart of an operation method of the touch device according to an embodiment of the disclosure. The touch device 100 includes a touch panel 110, a sensing unit 120 and a processing unit 130.

An object 140 can touch the touch panel 110, so that the touch panel 110 can sense a touch. Thus, the sensing unit 120 outputs a corresponding touch signal according to the touch. The processing unit 130 receives the touch signal to perform a corresponding control. The object 140 can be, for example, a finger of a user or a touch pen.

Moreover, the touch panel 110 includes a triggering zone 111 and a working zone 112. The working zone 112 is set in a range surrounded by a dotted line, and the triggering zone 111 is set outside of the range surrounded by the dotted line. The object 140 can touch the working zone 112, and the triggering zone 111 is, for example, a non-working zone, i.e. a rim of the touch panel 110. The triggering zone 111 can wholly surround the edge of the working zone 112. In this and some embodiments, the triggering zone 111 can be disposed on any one side, any two sides or any three sides of the edge of the working zone 112. The operation method of the touch device 100 is described as follows.

In step S210, the touch signal is received, and the touch signal is generated by the touch panel 110 sensing a touch. For example, an object 140 (a finger of a user or a touch pen) touches the touch panel 110, so that the sensing unit 120 senses the touch of the object 140 on the touch panel 110 to generate the touch signal. Subsequently, the processing unit 130 receives the touch signal to perform a corresponding control.

In step S220, according to the touch signal, whether a location of the touch caused by the object 140 moves from the triggering zone 111 to the working zone 112 on the touch panel 110 is determined. In other words, when the processing unit 130 receives the touch signal, the processing unit 130 processes and analyzes the touch signal to obtain a location and a trace of the object 140 touching the touch panel 110, and then determines whether the object 140 moves from the triggering zone 111 to the working zone 112.

When the location of the touch (the object 140) moves from the triggering zone 111 to the working zone 112, e.g. the object 140 in FIG. 1 moves along an arrowed direction, the processing unit 130 performs step S230 to control the touch panel 110 to operate under a multi-touch mode. In other words, the processing unit 130 enters the multi-touch mode to switch the touch panel 110 to operate under the multi-touch mode, so as to allow the user to perform the multi-touch operation on the touch device 100.

In contrast, when the location of the touch (the object 140) does not move from the triggering zone 111 to the working zone 112, the processing unit 130 performs step S240 to control the touch panel 110 to operate under a mouse mode. In other words, the processing unit 130 enters into the mouse mode to switch the touch panel 110 to operate under the mouse mode. Herein, the user can operate the touch device 100 as the same as operating a mouse.

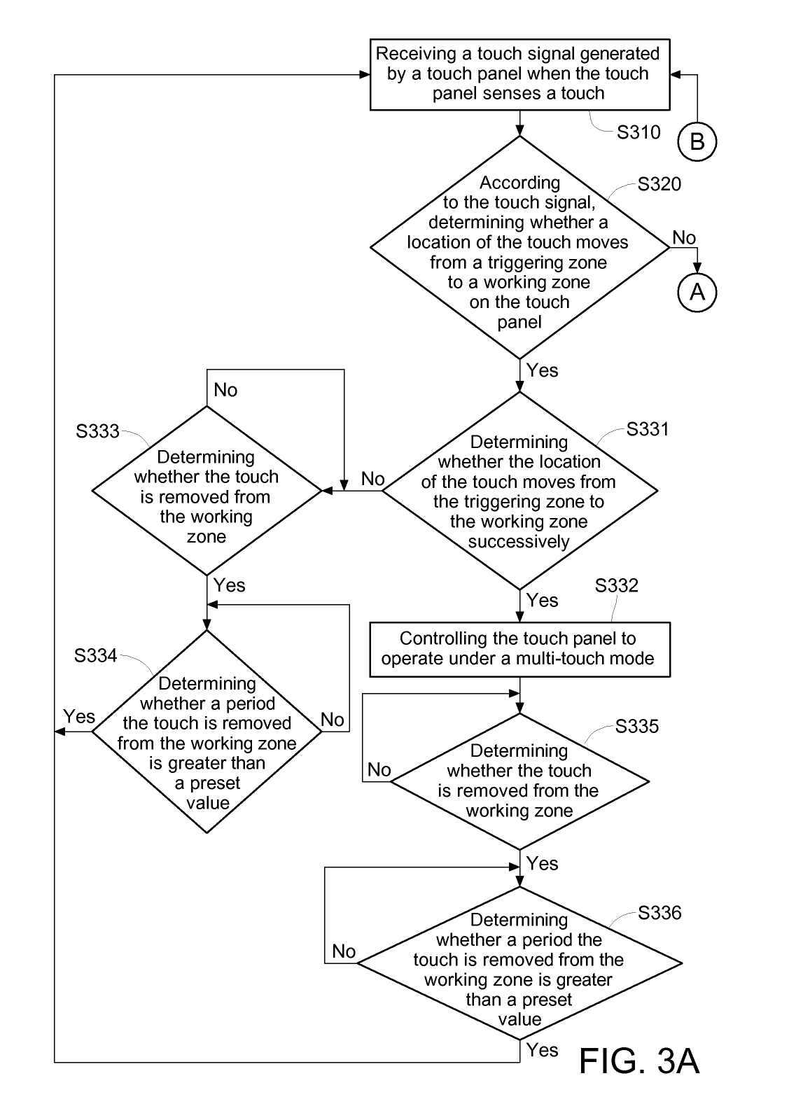

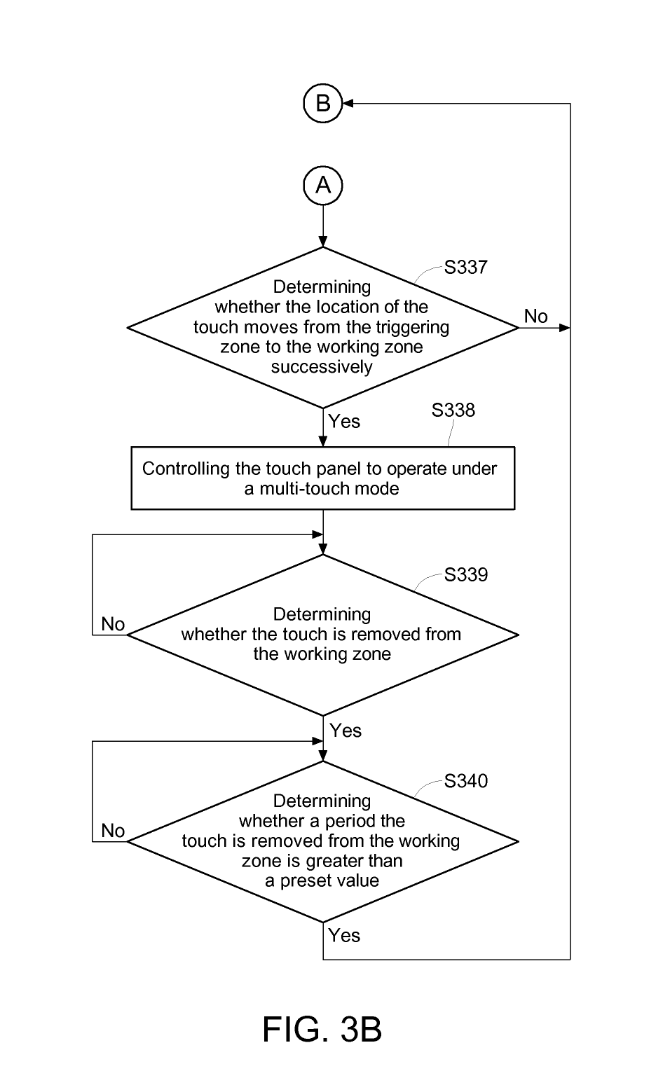

FIG. 3A and FIG. 3B illustrate a flow chart of an operation method of the touch device according to another embodiment of the disclosure. In step S310, the touch signal is received, and the touch signal is generated by the touch panel 110 sensing a touch. For example, when the object 140 (the finger of a user or the touch pen) touches the touch panel 110, the sensing unit 120 senses the touch of the object 140 on the touch panel 110 to generate a touch signal. Subsequently, the processing unit 130 receives the touch signal to perform a corresponding control.

In step S320, according to the touch signal, whether the location of the touch (the object 140) moves from the triggering zone 111 to the working zone 112 on touch panel 110 is determined. In other words, when the processing unit 130 receives the touch signal and then processes and analyzes the touch signal to obtain the location and trace of the object 140 touching the touch panel 110. Accordingly, the processing unit 130 determines whether the object 140 moves from the triggering zone 111 to the working zone 112.

When the location of the touch (the object 140) moves from the triggering zone 111 to the working zone 112, e.g. the object 140 in FIG. 1 moves in an arrowed direction, the processing unit 130 performs the step S331 to determine whether the location of the touch (the object 140) moves from the triggering zone 111 to the working zone 112 successively.

When the location of the touch (the object 140) moves from the triggering zone 111 to the working zone 112 successively (for example, after contacting the triggering zone 111, the object 140 continues moving to the triggering zone 111 but is not removed from the touch panel 110), the processing unit 130 performs the step S332 to control the touch panel 110 to operate under the multi-touch mode. In other words, the processing unit 130 enters the multi-touch mode to switch the operation mode of the touch panel 110 to the multi-touch mode. Accordingly, the user can perform the multi-touch operation on the touch device 100.

In contrast, when the location of the touch (the object 140) does not move from the triggering zone 111 to the working zone 112 successively (for example, the object 140 is removed from the touch panel 110 after contacting the triggering zone 111 for a while, and then contacts the working zone 112 again), the processing unit 130 performs step S333. In step S333, the processing unit 130 determines whether the object 140 is removed from the working zone 112, i.e. the processing unit 130 determines whether the touch is removed from the working zone 112.

When the touch is not removed from the working zone 112 (the object 140 is not removed from the working zone 112), the processing unit 130 returns to step S333 to continuously determine whether the object 140 is removed from the working zone 112, until the object 140 is removed from the working zone 112. In contrast, when the touch is removed from the working zone 112 (the object 140 is removed from the working zone 112), the processing unit 130 performs step S334 to determine whether a time period the touch is removed from the working zone 112 (i.e. the object 140 is removed from the working zone 112) is greater than a preset value, e.g. 2 seconds. Accordingly, the processing unit 130 can ensure that the object 140 has been removed from the working zone 112.

When the time period is greater than the preset value, the processing unit 130 returns to step S310 to receive a new touch signal and determine the operation mode again. In contrast, when the time period is not greater than the preset value, the processing unit 130 returns to step S334 to continuously determine whether the time period the object 140 is removed from the working zone 112 is greater than the preset value, until the time period is greater than the preset value.

Subsequently, after entering the multi-touch mode in step S332, in step S335, the processing unit 130 determines whether the touch is removed from the working zone 112. If the touch is removed from the working zone 112, the processing unit 130 returns to step S332 to control the touch panel 110 to continuously operate under the multi-touch mode. In other words, the operation mode of the processing unit 130 will not be changed, so that the user can still perform the multi-touch operation on the touch panel 110.

When the touch is removed from the working zone 112, the processing unit 130 performs step S336 to determine whether the time period the touch is removed from the working zone 112 is greater than the preset value, e.g. 2 seconds. Accordingly, the processing unit 130 can ensure that the object 140 has been removed from the working zone 112.

When the time period is greater than the preset value, the processing unit 130 returns to step S310 to receive a new touch signal and determine the operation mode again. In contrast, when the time period is not greater than the preset value the processing unit 130 returns to step S336 to determine whether the time period is greater than the preset value, until the time period is greater than the preset value.

In step S320, when the location of the touch (the object 140) does not move from the triggering zone 111 to the working zone 112, the processing unit 130 performs step S337 to determine whether the object 140 touches the working zone 112 directly. In other words, the processing unit 130 determines whether the touch occurs by directly touching the working zone 112 in the beginning of the touch operation.

When the touch does not occur by directly touching the working zone 112, the processing unit 130 returns to step S310 to receive a new touch signal and determine the operation mode again. When the touch occurs by directly touching the working zone 112, the processing unit 130 performs step S338 to control the touch panel 110 to operate under the mouse mode. In other words, the processing unit 130 switches the corresponding operation mode of the touch panel 110 to the mouse mode, so that the user can operate the touch device 100 as the same as operating a mouse.

In step S339, the processing unit 130 determines whether the object 140 is removed from the working zone 112, i.e. the processing unit 130 determines whether the touch is removed from the working zone 112. When the touch is not removed from the working zone 112, the processing unit 130 returns to step S338 to control the touch panel 110 to operate under the mouse mode. In other words, the processing unit 130 does not switch the operation mode, and the user can still operate the touch panel 110 as the same as operating a mouse.

When the touch is removed from the working zone 112, the processing unit 130 performs step S340 to determine whether the time period the object 140 is removed from the working zone 112 is greater than the preset value, e.g. 2 seconds. In other words, the processing unit 130 determines whether the time period the touch is removed from the working zone 112 is greater than the preset value, so as to ensure that the object 140 has been removed from the working zone 112.

When the time period is greater than the preset value, the processing unit 130 returns to step S310 to receive a new touch signal and determine the operation mode again. When the time period is not greater than the preset value, the processing unit 130 returns to the step S340 to determine whether the time period is greater than the preset value, until the time period is greater than the preset value.

In the operation method of a touch panel in the disclosure, according to the touch signal, whether the location of the touch, e.g. an object, moves from the triggering zone to the working zone, or whether the touch occurs by directly touching the working zone can be determined, so that the touch panel can be controlled to operate under the multi-touch mode or the mouse mode. In this way, the operation modes of the touch panel can be increased, thereby being convenient to use.

What is claimed is:

1. An operation method of a touch panel, comprising:
receiving a touch signal generated by the touch panel when the touch panel senses a touch;
according to the touch signal, determining whether a location of the touch moves from a triggering zone to a working zone on the touch panel;
when the location of the touch moves from the triggering zone to the working zone, controlling the touch panel to operate under a multi-touch mode; and
when the location of the touch does not move from the triggering zone to the working zone, controlling the touch panel to operate under a mouse mode.

2. The operation method of the touch panel according to claim 1, wherein, when the location of the touch moves from the triggering zone to the working zone, the step of controlling the touch panel to operate under the multi-touch mode comprises:
determining whether the location of the touch moves from the triggering zone to the working zone successively;
when the location of the touch moves from the triggering zone to the working zone successively, controlling the touch panel to operate under the multi-touch mode; and
when the location of the touch does not move from the triggering zone to the working zone successively, returning to the step of receiving the touch signal.

3. The operation method of the touch panel according to claim 2, wherein, when the location of the touch does not move from the triggering zone to the working zone successively, the operation method further comprises the following steps before the step of returning to the step of receiving the touch signal:
determining whether the touch is removed from the working zone;
when the touch is not removed from the working zone, returning to the step of determining whether the touch is removed from the working zone; and
when the touch is removed from the working zone, performing the step of returning to the step of receiving the touch signal.

4. The operation method of the touch panel according to claim 3, wherein, when the touch is removed from the working zone, the operation method further comprises the following steps before the step of returning to the step of receiving the touch signal:
determining whether a time period the touch is removed from the working zone is greater than a preset value;
when the time period is greater than the preset value, performing the step of returning to the step of receiving the touch signal; and
when the time period is not greater than the preset value, returning to the step of determining whether the time period the touch is removed from the working zone is greater than the preset value.

5. The operation method of the touch panel according to claim 1, wherein after the step of controlling the touch panel to operate under the multi-touch mode, the operation method further comprises:
determining whether the touch is removed from the working zone;
when the touch is not removed from the working zone, controlling the touch panel to continuously operate under the multi-touch mode; and
when the touch is removed from the working zone, returning to the step of receiving the touch signal.

6. The operation method of the touch panel according to claim 5, wherein, when the touch is removed from the working zone, the operation method further comprises the following steps before the step of returning to the step of receiving the touch signal:
determining whether a time period the touch is removed from the working zone is greater than a preset value;
when the time period is greater than the preset value, performing the step of returning to the step of receiving the touch signal; and
when the time period is not greater than the preset value, controlling the touch panel to continuously operate under the multi-touch mode.

7. The operation method of the touch panel according to claim 1, wherein, when the location of the touch does not move from the triggering zone to the working zone, the operation method further comprises the following steps after the step of controlling the touch panel to operate under the mouse mode:
determining whether the touch is removed from the working zone;
when the touch is not removed from the working zone, controlling the touch panel to continuously operate under the mouse mode; and
when the touch is removed from the working zone, returning to the step of receiving the touch signal.

8. The operation method of the touch panel according to claim 7, wherein, when the touch is removed from the working zone, the operation method further comprises the following steps before the step of returning to the step of receiving the touch signal:
determining whether a time period the touch is removed from the working zone is greater than a preset value;
when the time period is greater than the preset value, performing the step of returning to the step of receiving the touch signal; and
when the time period is not greater than the preset value, controlling the touch panel to continuously operate under the mouse mode.

9. The operation method of the touch panel according to claim 1, wherein, when the location of the touch does not move from the triggering zone to the working zone, the step of controlling the touch panel to operate under the mouse mode comprises:
determining whether the touch occurs by directly touching the working zone;
when the touch occurs by directly touching the working zone, controlling the touch panel to operate under the mouse mode; and
when the touch occurs by not directly touching the working zone, returning to the step of receiving the touch signal.
